(19) United States
(12) Patent Application Publication
(10) Pub. No.: US 2021/0110243 A1
(43) Pub. Date: Apr. 15, 2021

(54) DEEP LEARNING ACCELERATOR SYSTEM INTERFACE

(71) Applicant: Hewlett Packard Enterprise Development LP, Houston, TX (US)

(72) Inventors: CRAIG WARNER, Plano, TX (US); Chris Michael Brueggen, Plano, TX (US); Eun Sub Lee, Plano, TX (US)

(21) Appl. No.: 16/598,329

(22) Filed: Oct. 10, 2019

(51) Int. Cl. G06N 3/063; G06N 5/04; G06F 9/38; G06F 9/52; G06K 9/62

(52) U.S. Cl. CPC G06N 3/063; G06N 5/04; G06K 9/6217; G06F 9/522; G06F 9/3867

(57) ABSTRACT

Systems are methods are provided for implementing a deep learning accelerator system interface (DLASI). The DLASI connects an accelerator having a plurality of inference computation units to a memory of the host computer system during an inference operation. The DLASI allows interoperability between a main memory of a host computer, which uses 64 B cache lines, for example, and inference computation units, such as tiles, which are designed with smaller on-die memory using 16-bit words. The DLASI can include several components that function collectively to provide the interface between the server memory and a plurality of tiles. For example, the DLASI can include: a switch connected to the plurality of tiles; a host interface; a bridge connected to the switch and the host interface; and a deep learning accelerator fabric protocol. The fabric protocol can also implement a pipelining scheme which optimizes throughput of the multiple tiles of the accelerator.

### DESCRIPTION OF RELATED ART

Deep learning is an approach that is based on the broader concepts of artificial intelligence and machine learning (ML). Deep learning can be described as imitating biological systems, for instance the workings of the human brain, in learning information and recognizing patterns for use in decision making. Deep learning often involves artificial neural networks (ANNs), wherein the neural networks are capable of learning unsupervised from data that is unstructured or unlabeled. In an example of deep learning, a computer model can learn to perform classification tasks directly from images, text, or sound. As technology in the realm of AI progresses, deep learning models (e.g., trained using a large set of data and neural network architectures that contain many layers) can achieve state-of-the-art accuracy, sometimes exceeding human-level performance. Due to this growth in performance, deep learning can have a variety of practical applications, including function approximation, classification, data processing, image processing, robotics, automated vehicles, and computer numerical control.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A depicts an example of a deep learning accelerator system, including a deep learning accelerator system interface (DLASI) to connect multiple inference computation units to a host memory, according to some embodiments.

FIG. 1B depicts an example of an object recognition application utilizing the deep learning accelerator including the DLASI, according to some embodiments.

FIG. 1C illustrates an example of tile-level pipelining scheme of the DLASI, allowing the deep learning accelerator to coordinate memory access for images, inferences, and output of results in a multi-tile accelerator system, according to some embodiments.

FIG. 2A illustrates an example of the overlapping interval pipelining (OIP) scheme of the DLASI, according to some embodiments.

FIG. 2B illustrates example formats of tile instructions in accordance with a protocol of the DLASI, according to some embodiments.

FIG. 2C illustrates example formats of other tile instructions in accordance with a protocol of the DLASI, according to some embodiments.

FIG. 3A is an operation flow diagram of a process for executing request for data (RFD) tracking aspects for synchronization of data to tiles in the DLASI, according to some embodiments.

FIG. 3B is an operation flow diagram of a process for executing barrier management aspects for synchronization of data to tiles in the DLASI, according to some embodiments.

FIG. 4 is a conceptual diagram of an instruction flow between tiles for executing a RFD/barrier synchronization scheme of the DLASI, according to some embodiments.

FIG. 5 illustrates an example computer system that may include the hardware accelerator shown in FIG. 1A, according to some embodiments.

The figures are not exhaustive and do not limit the present disclosure to the precise form disclosed.

### DETAILED DESCRIPTION

Various embodiments described herein are directed to a deep learning accelerator system interface (DLASI). The DLASI is designed to provide a high bandwidth, low latency interface between cores (e.g., used for inference) and servers that may otherwise not have communicative compatibility (with respect to memory). Designing an accelerator made up of thousands of small cores can have several challenges, such as: coordinating the many cores, keeping the accelerator efficiency high in spite of radically different problem sizes, and doing these tasks without consuming too much of the power or die area. In general, coordinating thousands of Neural Network Inference cores is challenging for a single host interface controller. For example, if any common operation requires too much time in the host interface controller, the controller itself can become the performance bottleneck.

Furthermore, the sizes of different neural networks can vary substantially. Some neural networks can only have a few thousand weights, while other neural networks, such as those used in image recognition, may have over 100 million weights. Using large accelerators for every application may appear to be a viable brute-force solution. On the other hand, if a large accelerator is assigned to work on a small neural network, the accelerator may be grossly underutilized. Furthermore, modern servers host many OSes and only have capacity for a few expansion cards. For example, the HPE ProLiant DL380 Gen10 server (an example of a server with large expansion capabilities) has 3 PCIe card slots per processor socket. Large neural networks cannot be mapped onto a single die—there is simply not enough on-die storage to hold all of the weights. This drives the importance of multi-die solutions.

Typically, commodity servers (e.g. Xeon-based), personal computers (PCs), and embedded systems such as Raspberry Pi, run standardized operating systems and incorporate complex general purpose CPUs and cacheable memory systems. However, deep learning processors can achieve high performance with much simpler instruction set and memory architecture. In addition, a core's architecture is optimized for processing smaller numbers, for instance handling 8 bit numbers in operation (as opposed to 32 bits or 64 bits). The hardware design for a deep learning accelerator can include a substantially large number of processors, for instance using thousands of deep learning processors. Also, with being employed by the thousands, these deep learning processors may not require high precision, generally. Thus, processing small numbers may be optimal for its multi-core design, for instance mitigating bottlenecks. In contrast, commodity servers can run very efficiently handling larger numbers, for instance processing 64 bits. Due to these (and other) functional differences, there may be some incongruity between the cores and the servers during deep learning processing. The disclosed DLASI is designed to address such concerns, as alluded to above. The DLASI realizes a multi-die solution that efficiently connects the different types of processing (performed at the cores and the servers in an accelerator) for interfacing entities in the accelerator system, thereby improving compatibility and enhancing the system's overall performance.

According to the embodiments, the DLASI includes a fabric protocol, a microcontroller-based host interface, and a bridge that can connect a server memory system, viewing memory as an array of 64 byte (B) cache lines, to a large number of DNN inferences computational units, namely the cores (tiles) that view memory as an array of 16-bit words. The fabric protocol can be two virtual channel (VC) protocol, which enables the construction of simple and efficient switches. The fabric protocol can support large packets, which in turn, can support high efficiencies. Additionally, by requiring simple ordering rules, the fabric protocol can be extended to multiple chips. Even further, in some cases, the fabric protocol can be layered on top of another protocol, such as Ethernet, for server to server communication. Furthermore, the host interface can interface with the server at an “image” level, and can pipeline smaller segments of work from the larger level, in a “spoon feeding” fashion, to the multiple cores. This is accomplished by applying a synchronization scheme, referred to herein as overlapping interval pipelining. Overlapped interval pipelining can be generally described as a connection of send and barrier instructions. This pipelining approach enables each of the inference computation units, such as tiles, to be built with a small amount of on-die memory, and synchronizes work amongst the many tiles in a manner that minimizes idleness of tiles (thereby optimizing processing speed).

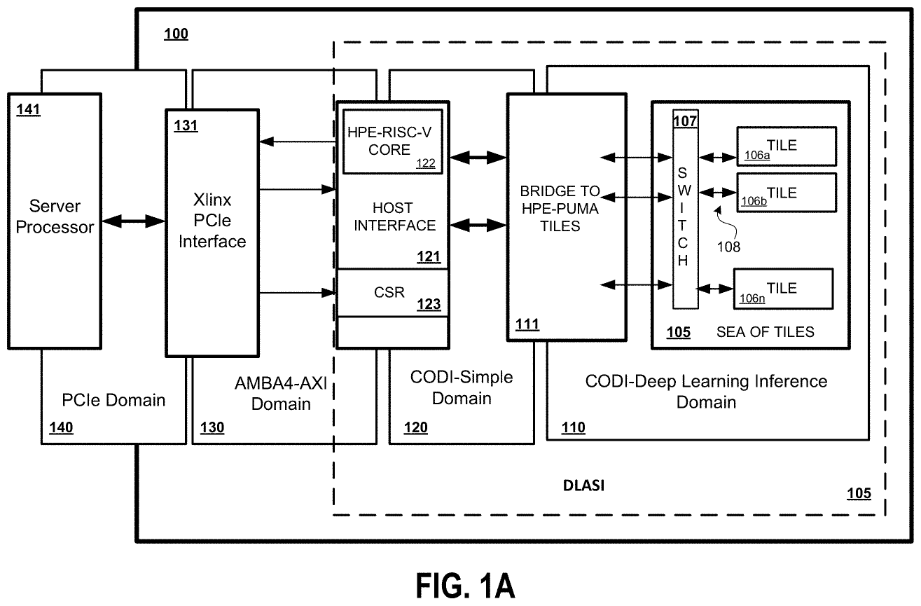

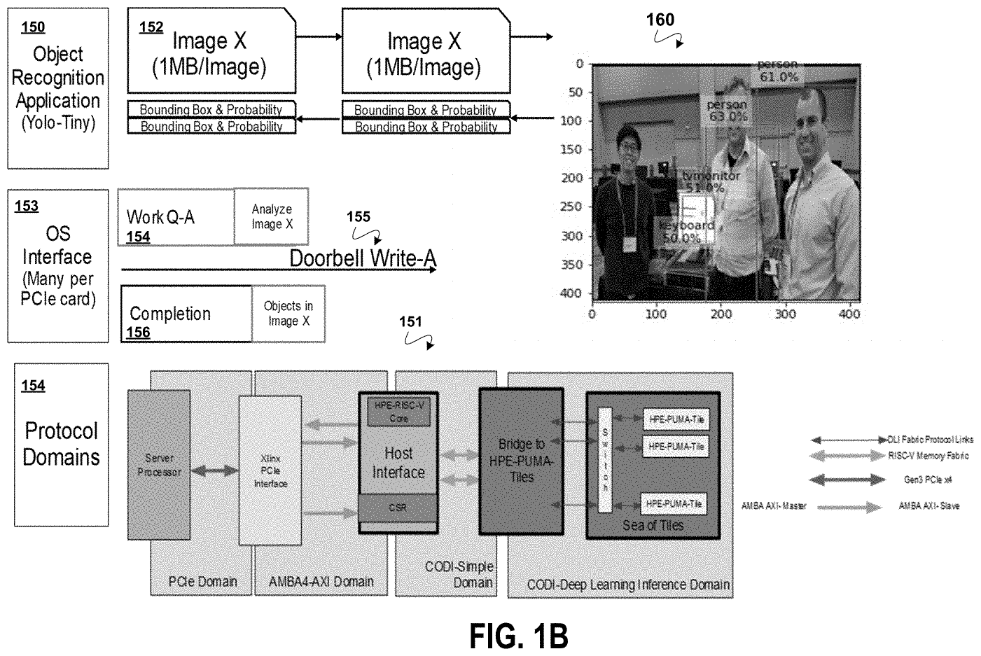

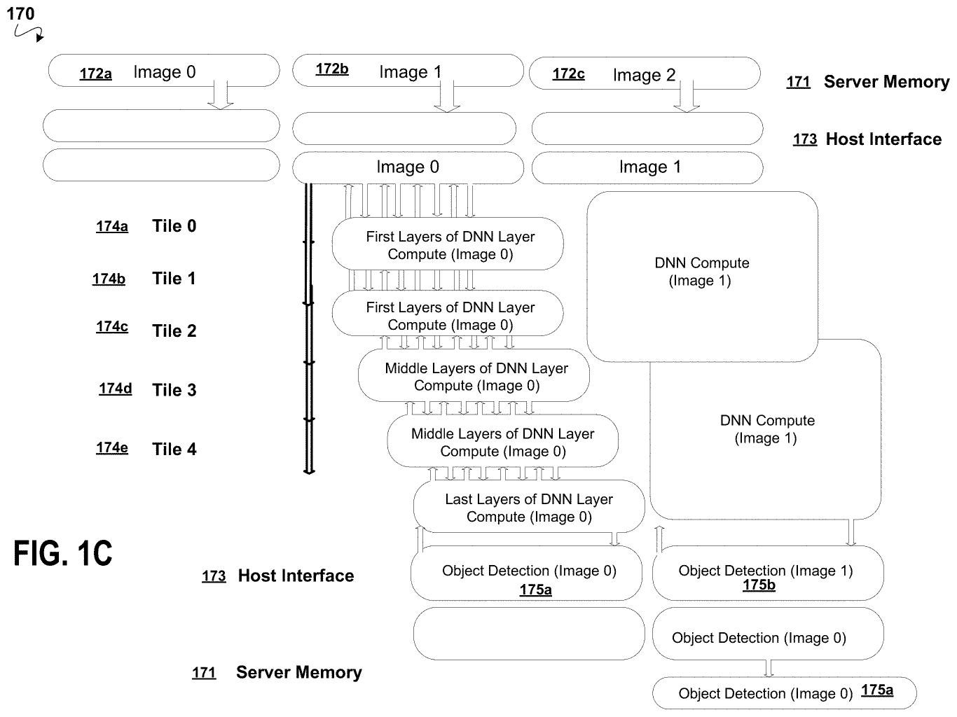

FIG. 1A illustrates an example of a deep learning accelerator 100, including the DLASI 105. The deep learning accelerator 100 can be implemented as hardware, for example as a field programmable gate array (FPGA) or other form of integrated circuit (IC) chip. As an FPGA, the accelerator 100 can include digital math units (as opposed to memrister-based analog compute circuits). The deep learning accelerator 100 can have an architecture that allows for a diverse range of deep learning applications to be run on the same silicon. As shown in FIG. 1A, the DLASI (indicated by the dashed line box) can be a conceptual collective of several components, including: the DLI fabric protocol links 108; the host interface 121; bridge 111; and switch 107. The deep learning accelerator 100 has an architecture that is segmented into four domains, including: a CODI-Deep Learning Inference domain 110; a CODI-Simple domain 120; a AMBA4-AXI domain 130; and a Peripheral Component Interconnect Express (PCIe) domain 140. Additionally, FIG. 1A serves to illustrate that the DLASI 105 can be implemented as an on-die interconnect, allowing the disclosed interface to be a fully integrated and intra-chip solution (with respect to the accelerator chip).

The PCIe domain 140 is shown to include a communicative connection between a server processor 141. The PCIe domain 140 can include the Xilinx-PCIe interface 131, as a high-speed interface for connecting the DLI inference chip to a host processor, for example a server processor. For example, a motherboard of the server can have a number of PCIe slots for receiving add-on cards. The server processor 141 can be implemented in a commodity server that is in communication with the tiles 106a-106n for performing deep learning operations, for example image recognition. As an example, the server processor 141 may be a Xeon server. As alluded to above, by supporting a multi-card configurations, larger DNNs can be supported by the accelerator 100. For a small number of FPGAs (e.g., four FPGAs) it would be possible to use the PCIe: peer to peer mechanism. In some cases, a PCIe link may not be able to deliver enough bandwidth and dedicated FPGA to FPGA links will be needed.

In the illustrated example, the CODI-Deep Learning Inference domain 110 includes the sea of tiles 105, plurality of tiles 106a-106n, switch 107, and bridge 111. As seen, the sea of tiles 10 is comprised of multiple tiles 106a-106n that are communicably connected to each other. Each tile 106a-106n is configured as a DNN inference computation unit, being capable of performing tasks related to deep learning, such as computations, inference processing, and the like. Thus, the sea of tiles 105 can be considered an on chip network of tiles 106a-106n, also referred to herein as the DLI fabric. The CODI-DLI domain 110 includes a CODI interconnect used to connect the tiles to one another and for connecting the tiles to a host interface controller 121.

Each of the individual tiles 106a-106n can further include multiple cores (not shown). For example, a single tile 106a can include 16 cores. Further, each core can include Matrix-Vector-Multiply-Units (MVMU). These MVMUs can be implemented with static random-access memory (SRAM) and digital multiplier/adders (as opposed to memristers). In an embodiment, the core can implement a full set of instructions, and employs four 256×256 MVMUs.

The cores in the tile are connected to a tile memory. Accordingly, the tile memory for tile 106a, for instance, can be accessed from any of the cores which reside in the tile 106a. The tiles 106a-106n in the sea of tiles in the sea of tiles 105 can communicate with one another by sending datagram packets to other tiles. The tile memory has a unique feature for managing flow control—each element in the tile memory has a count field which is decremented by reads and set by writes. Also, each of the tiles 106a-106n can have an on-die fabric interface (not shown) for communicating with the other tiles, as well as the switch 107. The switch 107 can provide tile-to-tile communication.

Accordingly, there is an on-die interconnect which allows the inference chip to interface with the PCIe domain 140. The CODI-Deep Learning Inference domain 110 is a distinct fabric connecting many compute units to one another.

The deep learning inference (DLI) fabric protocol links 108 are configured to provide communicative connection in accordance with the DLI fabric protocol. The DLI fabric protocol can use low-level conventions, for example those set forth by CODI. The DLI fabric protocol can be a 2 virtual channel (VC) protocol which enables the construction of simple and efficient switches. The switch 107 can be a 16-port switch, which serves as a building block for the design. The DLI fabric protocol can be implemented as a 2-VC protocol by having higher level protocols designed in a way that ensures the fabric stalling is infrequent. The DLI fabric protocol supports a large identifier (ID) space, for instance 16 bits, which in turn, supports multiple chips that may be controlled by the host interface 121. Furthermore, the DLI fabric protocol may use simple ordering rules, allowing the protocol to be extended to multiple chips.

The DLASI 105 also includes a bridge 111. As a general description, the bridge 111 can be an interface that takes packets from one physical interface, and transparently routes them to another physical interface, facilitating a connection therebetween. The bridge 111 is shown as an interface between the host interface 121 in the CODI-simple domain 120 and the switch 107 in the CODI-deep learning inference domain 110, bridging the domains for communication. Bridge 111 can ultimately connect a server memory (viewing memory as an array of 64B cache lines) to the DLI fabric, namely tiles 106a-106n (viewing memory as an array of 16-bit words). In embodiments, the bridge 111 has hardware functionality for distributing input data to the tiles 106a-106n, gathering output and performance monitoring data, and switching from processing one image to processing the next.

The host interface 121. The Host interface needs to supply input data and must transfer output data to the host server memory. To enable simple flow control the host interface declares when the next interval occurs, and is informed when a tile's PUMA cores have all reached halt instructions. When the host interface declares the beginning of the next interval each tile sends its intermediate data to the next set of tiles performing computation for the next interval.

In an example, when a PCIe card boots, a link in the PCIe domain 140 gets trained. For example, the link in the PCIe domain 140 can finish training, clocks start and the blocks are taken out of reset. Then, all the blocks in the card can get initialized. Then, when loading a DNN onto the card, the matrix weights are loaded, the core instructions are loaded, and the tile instructions are loaded.

Referring now to FIG. 1B, an example of an object recognition application utilizing the deep learning accelerator (shown in FIG. 1A) is illustrated. The object recognition application 150 can receive an image 152, such as frames of images that are streamed to a host computer in a video format (e.g., 1 MB). The image 152 is then sent to be analyzed, using DNN inference techniques, by the deep learning accelerator 151. The example particularly refers to a You Only Look Once (yolo)-tiny-based implementation, which is a type of DNN that can be used for video object recognition applications. In accordance with this example, Yolo-tiny can be mapped onto the deep learning accelerator 151. For instance, the deep learning accelerator 151 can be implemented in hardware as a FPGA chip that is capable of performing object recognition on a video stream using the Yolo-Tiny framework as a real-time object detection system.

An OS interface 153 at the host, which can send a request to analyze the data in a work queue 154. Next, a doorbell 155 can be sent as an indication of the request, being transmitted to the host interface of the accelerator 151 in the protocol domain 154. When work pertaining to image analysis is put into the work queue 154 by the OS interface 153, and the doorbell 155 is rung, the host interface can grab the image data from the queue. Furthermore, as the analysis results are obtained from the accelerator 151, the resulting objects are placed in the completion queue 156, and then transferring into server main memory. The host interface can read the request, then “spoon feed” the images using the bridge and the tiles (and the instructions running therein) which analyze the image data for object recognition. According to the embodiments, the DLI fabric protocol is the mechanism that allows for this “spoon feeding” of work to the tiles to ultimately be accomplished. That is, the DLI fabric protocol and the other DLASI components, previously described, link the protocol domain to the hardware domain.

The result of the object recognition application 150 can be a bounding box and probability that is associated with a recognized object. FIG. 1B shows depicts image 160 that may result from running the object recognition application 150. There are two bounding boxes around objects within the image 160 that have been identified as visual representations of a “person”, each having an associated probability shown as “63.0%” and “61.0%”. There is also an object in image 160 that is recognized as a “keyboard” at a “50.0%” probability.

FIG. 1C illustrates an example of tile-level pipelining, allowing different images to be clarified concurrently. In detail, FIG. 1C shows the multi-tile accelerator coordinating the DMAing of images, inferences, and results. As background, computationally, typical DNN algorithms are largely composed of combinations of matrix-vector multiplication and vector operations. DNN layers use non-linear computations to break the input symmetry and obtain linear separability. Cores are programmable and can execute instructions to implement DNNs, where each DNN layer is fundamentally expressible in terms of instructions performing low level computations. As such, multiple layers of a DNN are typically mapped to the multiple tiles of the accelerator in order to perform computations. Additionally, in the example of FIG. 1C, layers of a DNN for image processing are also mapped to tiles 174a-174e of the accelerator.

As seen, at a server memory level 171, an image 0 172a, image 1 172b, and an image 2 172c are sent as input to the be received by the multiple tiles 174a-174e in a pipeline fashion. In other words, all of the image data is not sent simultaneously. Rather, the pipelining scheme, as disclosed herein, involves staggering the transfer and processing of segments of the image data, shown as image 0 172a, image 1 172b, and image 2 172c. Prior to being received by the tiles 174a-144e, the images 172a-172c are received at the host interface level 173. The host interface level 173 transfers image 0 172a to the tiles 174a-174e first. In the example, the inference work performed by the tiles 174a-174e is shown as: tile 0 174a and tile 1 174b are used to map the first layers of DNN layer compute for image 0 172a; tile 2 174c and tile 3 174d are used to map the middle layers of DNN layer compute for image 0 172a; and tile 4 174e is used to map the last layers of DNN layer compute for image 0 172a. Then, as the pipeline advances, after completing the compute of the last layer, the object detection for image 0 175a is output to the host interface level 173. At a next interval in the pipeline, that object detection for image 0 175a is transferred to the server memory 171. Furthermore, in accordance with the pipelining scheme, while the object detection for image 0 175a is being sent to the server memory 175a, the object detection for image 1 175b is being transferring to the host interface level 173.

The early stages of Convolution Neural Network (CNN) inference require more iterations than the later stages of the CNN inference, so in some embodiments, additional resources (tiles or cores) are allocated to the more iterative stages. Overall, image recognition performance is determined by the pipeline advancement rate, and the pipeline advancement rate is set by the tile which takes the longest to complete its work. Before the beginning of every pipeline interval, the DNN interface sets up input data and captures the output data.

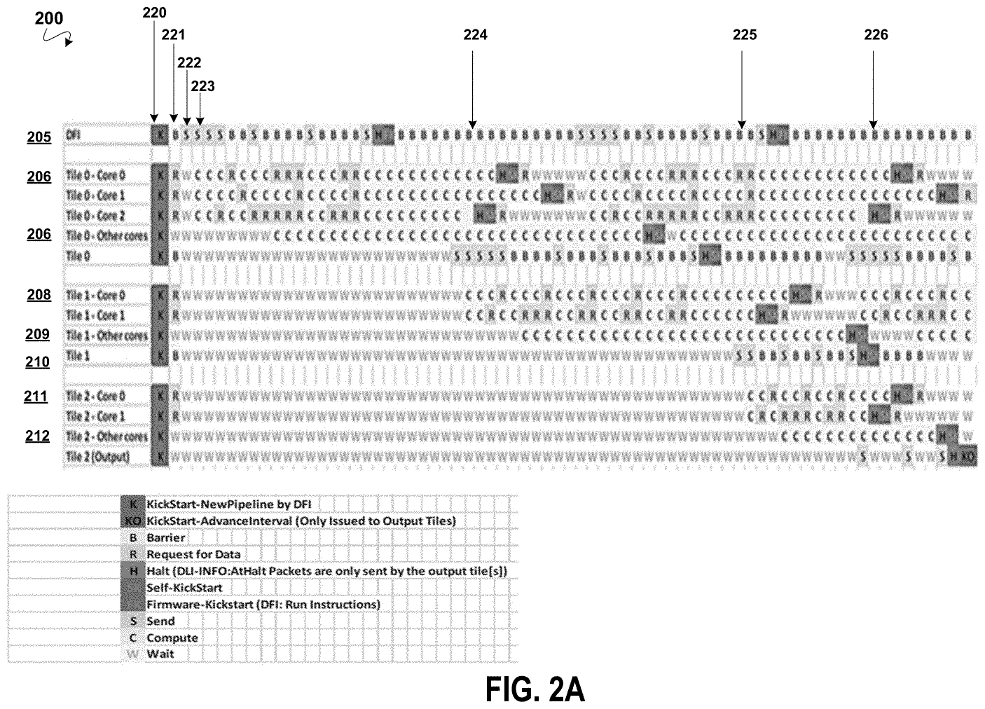

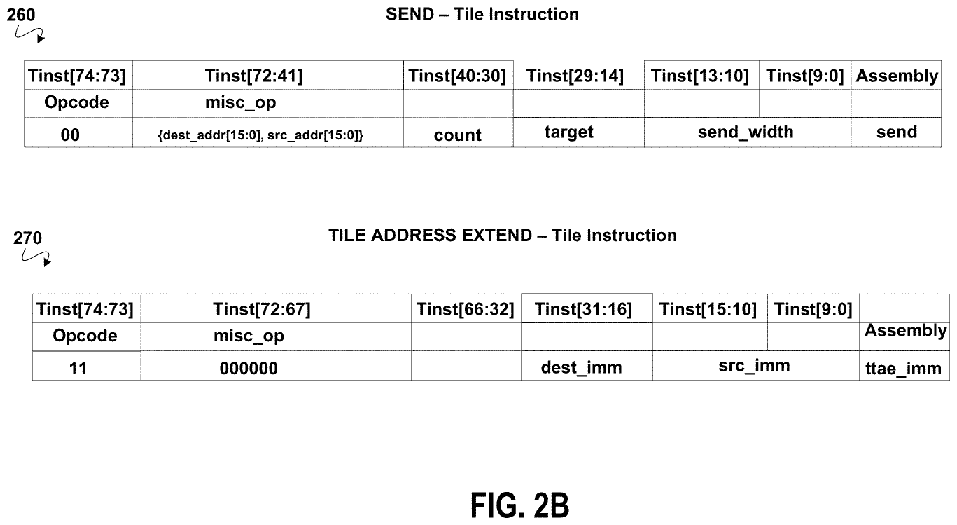

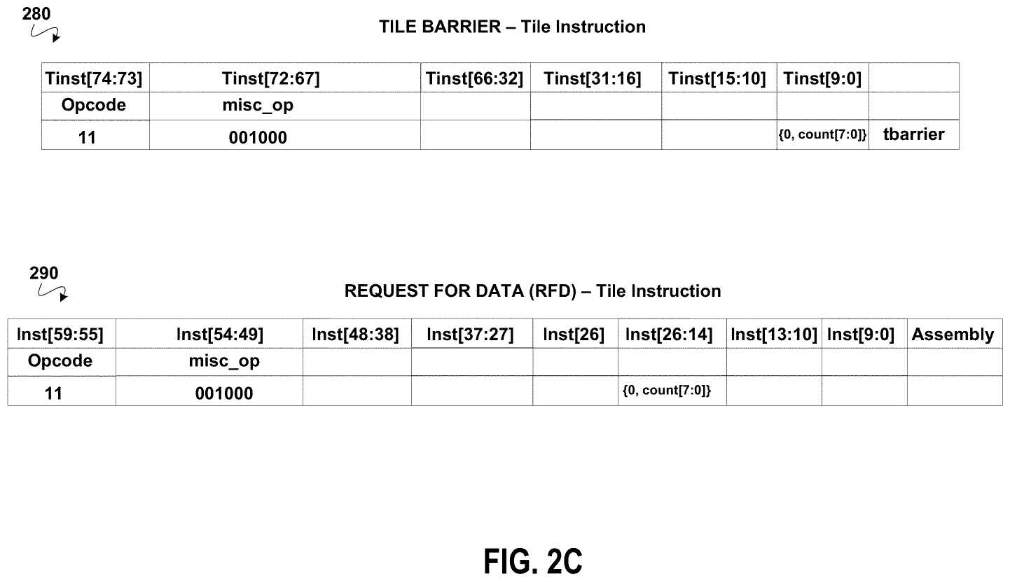

FIG. 2A depicts an example of a pipelining scheme, namely the overlapping interval pipeline (OIP) approach. The OIP approach can be implemented by the DLI fabric protocol, and runs a DNN in a manner that optimizes throughput of the multi-tiled accelerator (e.g., ensuring the cores are optimally running). Tiles are not particularly structured to handle large amounts of data, such as an entire image, due to their small size (with respect to physical size and processing resources). Consequently, a host processor can separate a DNN operation, such the processing of a larger image, into smaller segments of work, which can then be handed off to the multiple tiles in the accelerator. The OIP approach can support a more robust output data transfer. For instance, with OIP, the tile instruction unit of the output tile can be used to send data to the DLI or the other tiles. Furthermore, since the tile instruction buffer can be used, data can be pulled from many different regions of the output tile's memory.

As a general description, the OIP approach can process data in pipeline fashion, while allowing an overlap of various instruction-based tasks at the core level. This overlap can realize several advantages, such as mitigating excessive clock-cycles for a single instruction by allowing other tiles to continue to work. Thus, the OIP approach can increase the amount of work that can be accomplished by the multiple tiles in a given amount of time. For instance, the OIP may overlap accelerator transfers with output transfers, and well as computations.

In FIG. 2A, the example of the OIP scheme is illustrated as a matrix 200 representing the instructions that can be executed by various tiles during a particular interval of the pipeline. As seen, the matrix 200 includes rows 205-212, wherein row 205 corresponds to the DFI, and the remaining rows 206-212 correspond to a respective tile and core. For example, row 206 in matrix 200 represents a tile 0—core 0. Each of the columns 220-226 of the matrix 200 corresponds to a particular interval in the pipeline. Column 220 represents the initial interval which starts the pipeline scheme, and the successively adjacent columns correspond to the sequential intervals in the pipeline (increasing from left to right). At each intersection of a row and column, is a letter indicating a instruction that is being performed by the tile/core (row) at that interval (column). In order to make DFI simpler to design, the DLI-RFD packets which are for the DFI blocks should set the DCID to DCFI:CC0 (0xf000). Each tile can tag each cache line of data with an interval number and a tile number. This allows for the host interface to only transfer the cache lines with the PMON data. In some embodiments, software running on a server has the job of recognizing the data.

In the illustrated example, during the first pipeline interval represented by column 220 at the beginning of the pipeline, each tile/core is executing the kickstart instruction (indicated by “K’) for a new pipeline of the DFI. In the next consecutive interval represented by column 221, the DFI represented by row 205 is executing a barrier instruction (indicated by “B’) of the DLI fabric protocol. Meanwhile, tile 0—core 0 is executing a request for data instruction (indicated by “R’), and tile 0—other cores that are waiting (e.g., stalled from executing the next instruction)(indicated by “W’). Additionally, during pipeline interval of column 221: tile 1—core 0 represented by row 208 is executing the request for data instruction; tile 1—other cores represented by row 209 are executing the barrier instruction; tile 2—core 0 represented by row 211 is executing the request for data instruction, and the tile 2—other cores represented by row 212 are waiting. In general, wait (or stall) can happen in two cases: 1) when a core or tile instruction unit is blocked by a semaphore (i.e. tile memory “counts”) 2) when a core instruction unit is blocked by RFD. For example, regarding the tile instruction unit being blocked by a semaphore, when a tile is trying to execute a send instruction, if the source memory's count is zero, it cannot send until it becomes non-zero. For another example, when a core is trying to execute a store instruction to a tile memory location, if the tile memory's count is non-zero, it cannot proceed until it becomes zero.

In the subsequent interval represented by column 222, while the DFI of row 205 is executing the send instruction (indicated by “S”) sending data, each of the other tiles are waiting. Subsequently, in the following interval in the pipeline represented by column 223, the tile 0—core 0 of row 206 is executing the compute instruction (indicated by “C”), while the other tiles continue to wait. According to the pipelining scheme, each of the tiles start their respective compute in a staggered fashion. As seen in the example, tile 0 begins compute earliest in the pipeline, beginning during interval represented by column 223. Then, tile 1 initiates its compute, executing a first compute instruction during interval 224. Tile 2 follows in succession of tiles 1 and 0, starting its compute in the interval represented by column 224.

The illustrated example shows that there are tiles that are idle for some period of time in the scheme, primarily at the beginning of the pipeline (left of the matrix). For instance, in the early intervals of the pipeline, tile 0—other cores are waiting (indicated by “W”) for a number of successive intervals (^{˜}9 pipeline intervals), before these cores initiate compute (indicated by “C”). In addition, the cores of tile 1, and the cores of tile 2 are shown to wait (indicated by “W”) for an even longer time than the tile 0, in the scheme. As indicated by the long rows of “W” in the matrix 200 for tile 1 and tile 2, these tiles wait across a greater number of pipeline intervals. For example, tile 1—other cores are illustrated as waiting approximately 30 pipeline intervals before beginning to compute (indicated by “C”). However, the idle time of these tiles at the start of the pipeline is negligible as compared to the lengthy processing time for an entire deep learning operation. Referring again to the example of an image recognition application, the operation can run for extended time periods, for example streaming images to be processed for several days or even several months. Therefore, in comparison to running the accelerator for days, for example, some tiles being idle for several microseconds in order to initiate the pipelining scheme has a negligible impact on latency. There are small periods where some tiles are not busy in the OIP approach. Nonetheless, the scheme can still be considered to execute an optimal use of the processing capabilities of the tiles, for instance after the pipelining initially ramps up. In other words, OIP scheme performs tile-level pipelining in order to achieve higher levels of utilization for batch operations.

Referring now to FIG. 2B, examples of tile instructions that are implemented by the disclosed DLI fabric protocol are shown. In particular, example formats are shown for multiple tile instructions, including: send instruction 260; tile address extend instruction 270; tile barrier instruction 280; and request for data (RFD) instruction. According to the embodiments, these tile instruction enable the OIP scheme as described above, for instance instructing a tile to send data at the appropriate time.

The send instruction 260 is for sending data to/from the tile memory of a tile to the tile memory of another tile. The count value to be written into the destination's tile memory is also specified in the instruction. For example, when a destination tile receives a send message on the fabric, the count value should be zero or “infinite read”. The send instruction 260 can have the format below:

send <dest_addr>,<src_addr>,<target>,<count>,<send_width>
<dest_addr>=Starting destination tile memory address (target tile).
<src_addr>=Starting source tile memory address.
<target>=tile or host to receive the data.
<count>=count value to be written into the tile memory attribute field.
<send_width>=number of tile memory word to send

The tile address extend instruction 270 can be used to extend the tile memory address range for tile send instructions. The tile address extend instruction 270 can have the format below:

ttae_imm <src_imm><dest_imm>
<src_imm>=immediate value of the upper tile address bits for the source tile
<dest_imm>=immediate value of the upper tile address bits for the destination tile

The tile barrier instruction 280 can be used stall a tile from sending data too fast.

The tile barrier instruction 260 can have the format below:

barrier <count>
<count>=immediate value specifying the number of DLI-INFO:RFD packets which should be received before proceeding.

The RFD instruction 290 can be used by a core to indicate to a tile that it is ready for more data. Also, a variation of the instruction, request for data stall (RFDS) can be used. The RFD instruction 290 can have the format below:

rfd or rfds

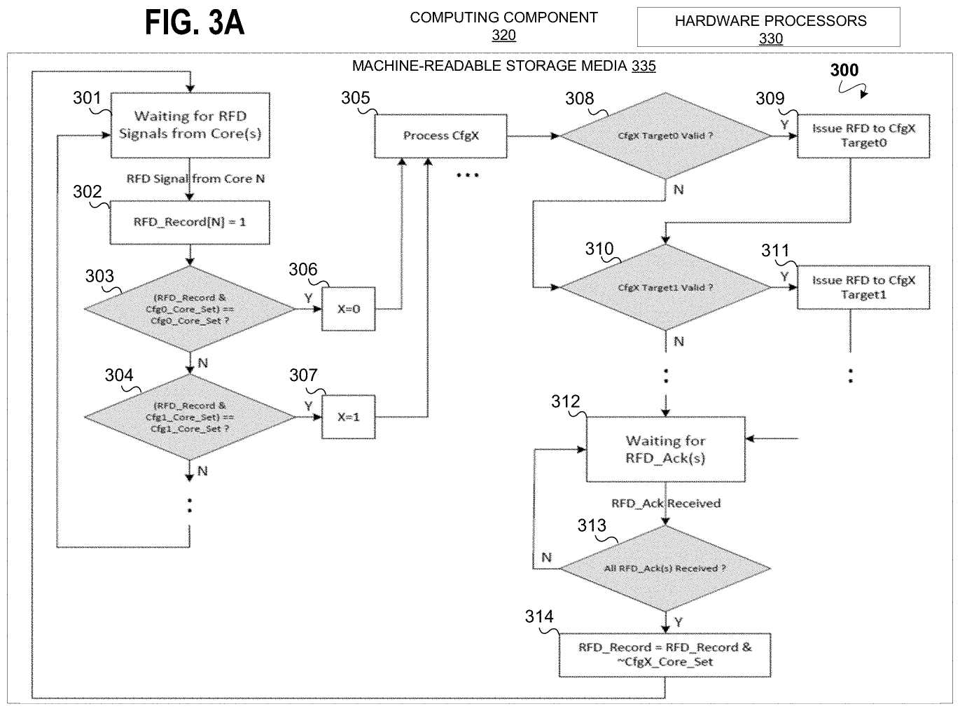

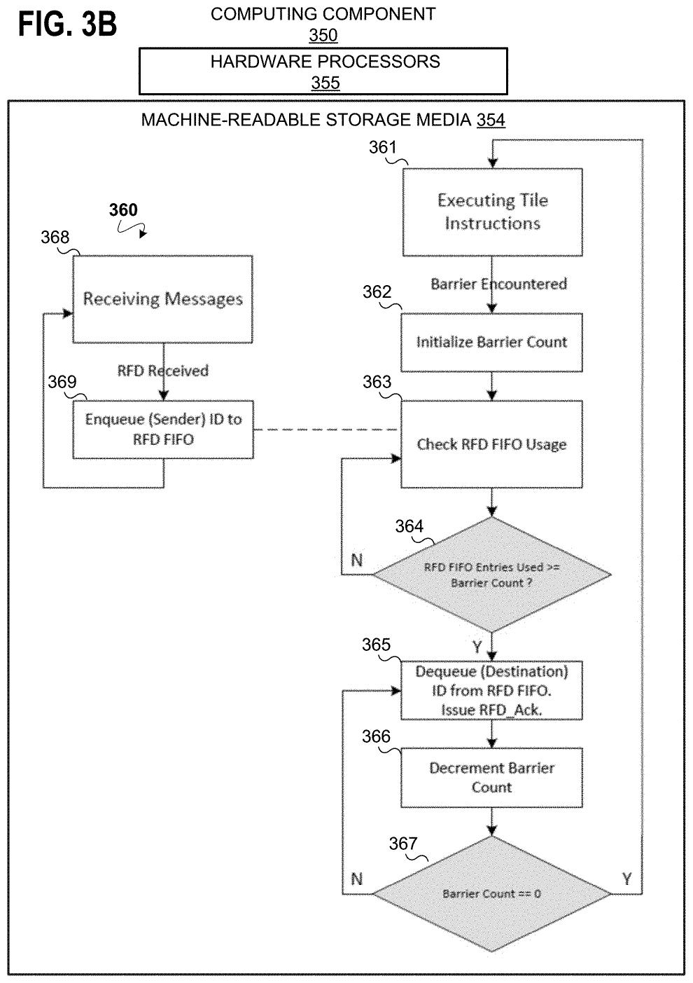

FIGS. 3A-3B illustrate examples of an RFD tracking thread and a barrier management thread, respectively, that may be employed by a tile in accordance with the disclosed OIP scheme. For instance, a tile can synchronize incoming data by using the RFD tracking shown in FIG. 3A. In contrast, a tile can synchronize outgoing data by using barrier management, as depicted in FIG. 3B. Although the RFD instruction itself is executed by the core, the RFD tracking and issuing of the RFD packet(s) are performed by tiles. With respect to barrier management, the various aspects of the scheme (e.g., barrier management, RFD packet receiving) are done by tiles.

FIG. 3A depicts an example of a process 300 with which a tile can participate in the OIP scheme as a receiver of data, and performing RFD tracking. In detail, FIG. 3A illustrates an example of a process 300 as a series of executable operations stored in a machine-readable storage media 335, and being performed by hardware processors 330 in a computing component 320. Hardware processors 300 can execute the operations of process 300, thereby implementing the disclosed RFD tracking described herein.

The process 300 can initiate at operation 301, where a tile is waiting for RFD signals from the core(s). Then, when a core executes an RFD instruction (as shown in FIG. 2C), it results in an RFD signal being sent to the tile. The core then stalls execution, waiting for an indication from the tile that the RFD signal has been processed. Next, at operation 302, the tile can maintain a record of observed RFD signals, which is compared to a list of cores (shown in FIG. 3A as “RFD_Record[N]=1”). This comparison, which is executed successively at operations 303 and 304 during process 300, allows the tile to determine when all of the cores in a configured set have executed correlated RFD instructions. This indicates that the cores, collectively, are ready to receive a new data set. The tile processes the RFD record, by issuing RFD packet(s) to one or more other tiles (or the host interface) during operations 309 and 311, and waiting for an RFD_ACK packet, during operation 312, for each RFD packet that was issued. Subsequently, a check is executed at operation 313 to determine whether all of the RFD_ACK packets have been received. When all expected RFD_ACK packets have been received (represented in FIG. 3A as “Y”), the new data set is known to have been transferred to the tile memory. Alternatively, if all of the RFD_ACK packets have not been received (represented in FIG. 3A as “N”), the tile can continue to wait, returning to operation 312. At operation 314, the tile clears entries in the RFD record which are observable by the corresponding cores (shown in FIG. 3A as “RFD_Record=RFD_Record & ^{˜}CfgX_Core_Set”). This is effectively a signal to the cores that they may resume execution.

Referring now to FIG. 3B, a process 360 is depicted, where a tile participates in the OIP scheme as a sender of data, and performing barrier management. FIG. 3B also illustrates the process 360 as a series of executable operations stored in a machine-readable storage media 354, and being performed by hardware processors 355 in a computing component 350. Hardware processors 355 can execute the operations of process 360, thereby implementing the disclosed RFD tracking described herein. This process 360 can involve two related functions in the tile which operate concurrently. These two functions can include: 1) the tile receiving message packets from the DLI fabric during operation 368, some of which may be RFD packets issued by other tiles; and 2) the tile instruction unit executing the tile instructions during operation 361, some of which may be barrier instructions. For instance, when a RFD packet is received, the ID of the sending tile can be stored in a FIFO structure at operation 369. Later, that ID can be used to send a corresponding RFD_ACK packet.

At operation 361, while executing the tile instructions, a barrier instruction may be encountered. The barrier is executed by first initializing the counter with a count value specified in the instruction during operation 362. A check can be performed at operation 364, where the counter is compared to the number of RFD packets which have been received and not yet acknowledged (i.e., the number of entries used in the FIFO, and shown in FIG. 3A as “RFD FIFO Entries Used >=Barrier Count”). When the number of entries used in the FIFO is greater than or equal to the barrier count (represented in FIG. 3B as “Y”), the process 360 moves to operation 365 where tile begins to remove, or dequeue, entries from the FIFO. Each entry contains an ID corresponding to a tile, which is used to construct and issue an RFD_ACK packet to the other tile. The barrier count is decremented during operation 366, as each RFD_ACK packet is issued. Next, a check can be performed at operation 367 to determine when the barrier count has been completely decremented, which is indicated by the barrier count reaching the value 0. When the barrier reaches 0 (represented in FIG. 3B as “Y”), then the barrier has been fully executed, and the tile can return to operation 361 to proceed to the next instruction.

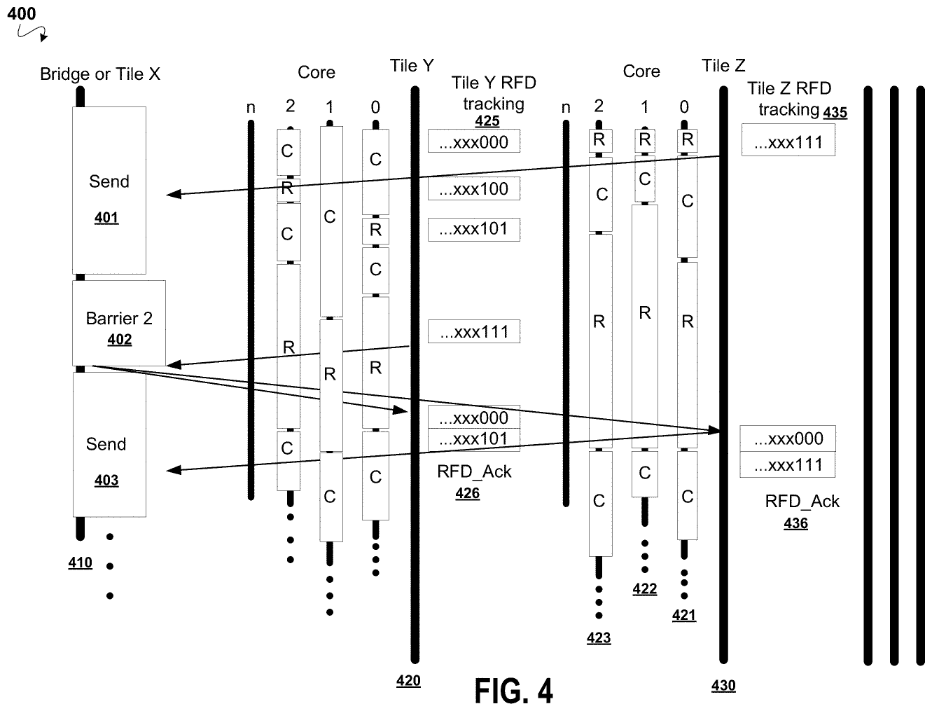

FIG. 4 is a conceptual diagram of an instruction flow 400, illustrating the communication of various instructions that can be involved with executing a RFD/barrier synchronization scheme. As described above, during OIP, tiles can interact with each other, functioning primarily as either senders of data or receivers of data. In the illustrated example, the operational flow 400 involves interactions between tile X (or bridge) 410, tile Y 410, and tile 430. At tile X 410, execution of the send instructions 401, 403 and barrier instruction 402 are represented. A first send instruction 401, can be executed by tile X (or barrier). The barrier instruction 402 can be executed by the tile X as a synchronizing point. At this point defined by the barrier instruction 402, tile X (or bridge) must receive an expected number of RFD packets from other tiles, before proceeding to the next instruction 403. Next, at tile Y 420, tile management of the RFD instructions executed by the cores within that tile is represented. In the illustrated example, tile Y 420 is shown to include core-0 421, core-1 422, and core-2 423. At each of the cores 421, 422, 423, the execution of the instructions within the core is represented. As shown, a core, for instance core-0 421 generally executes a series of non-RFD instructions (represented in FIG. 4 as “C”). Also, a core can encounter an RFD instruction (represented in FIG. 4 as “R”), which it executes and stalls for a length of time. In the example, the core-0 421 particularly executes a series of instructions. As seen, core-0 421 initially executes an RFD instruction, followed by a non-RFD instruction, and then another RFD instruction, and subsequently another non-RFD instruction.

Tile-level RFD synchronization is represented as RFD tracking 425, 435 that may be performed by the tile Y 420 and tile Z 430, respectively. The contents of the RFD tracking 425, 435 can indicate a set of cores from which the RFD signals have been received, compared to a configured list of cores (as described in FIG. 3A). In the example, the RFD tracking 425 of tile Y can correspond to RFD signals being received from cores “xxx000”, and the RFD tracking 435 of tile Z can correspond to RFD signals received from cores “xxx111”. Furthermore, as illustrated in FIG. 4, the RFD tracking 425, 435 can be transmitted from tile Y 420 and tile Z 430, respectively, to the bridge 410 (represented in FIG. 4 by left-facing arrows). An RFD packet is issued when RFD tracking indicates that all cores in a configured list have executed correlated RFD instructions. In response, the bridge 410 can transmit RFD_Ack packets 426, 436 back to tile Y 420 and tile Z 430. These RFD_Acks 426, 436 are issued, collectively, when an expected number of RFD packets have been received, as indicated by the barrier instruction 402. In the example, the RFD_Acks 426, 436 indicate that the RFD instructions of cores “xxx000” have completed execution (corresponding to tile Y RFD tracking 425), and that RFD instructions of cores “xxx111” have completed execution (corresponding to tile Z RFD tracking 435). As a result, the “incoming data” and “outgoing data” for each of the multiple tiles in the disclosed DLASI can be synchronized, allowing the tiles to perform inference on data in a pipelined scheme.

Accordingly, the DLASI disclosed herein provides a high bandwidth, low latency interface that realizes several advantages associated with deep learning accelerators. For example, the DLASI design supports a high inference-per-watt performance of the accelerator system. As a result, the overall efficiency of the system can improve, for instance enabling the accelerator to analyze more images-per-second. Furthermore, as the pipelining aspect of the DLASI optimizes utilization of all of the tiles in the accelerator, it allows the accelerator to achieve efficient processing at low power, and a small silicon footprint.

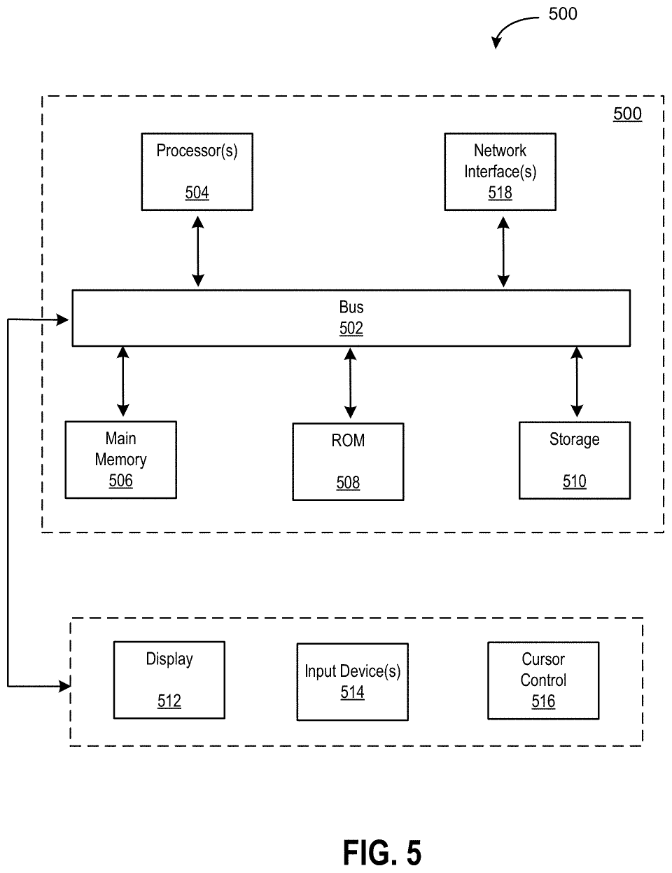

FIG. 5 depicts a block diagram of an example computer system 500 in which the deep learning accelerator (shown in FIG. 1A) described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 508, such as a random-access memory (RAM), cache and/or other dynamic storage devices, coupled to bus 502 for storing information and instructions to be executed by processor 504. Main memory 508 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes storage devices 510 such as a read only memory (ROM) or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 508. Such instructions may be read into main memory 508 from another storage medium, such as storage device 510. Execution of the sequences of instructions contained in main memory 508 causes processor(s) 504 to perform the process steps described herein. In alternative embodiments, hard-wired circuitry may be used in place of or in combination with software instructions.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A deep learning accelerator system, comprising:
a plurality of inference computation units;
a hardware interface to a memory of a host computer;
and a deep learning accelerator system interface for communicatively connecting the plurality of inference computation units to the memory of the host computer system during an inference operation.

2. The deep learning accelerator system of claim 1, wherein the memory of the host computer operates in accordance with cache-line configuration.

3. The deep learning accelerator of system 2, wherein the plurality of inference computation units are a plurality of tiles each tiles having a tile memory that operates in accordance with a word configuration.

4. The deep learning accelerator of system 3, wherein the deep learning accelerator system interface comprises:
a switch, wherein the switch is connected to the plurality of tiles;
a host interface, wherein the host interface is connected to the hardware interface; and
a bridge, wherein the bridge is connected to the switch and the host interface, and facilitates a first communicative connection with the plurality of tiles in accordance with a deep learning interface fabric protocol associated with the plurality of tiles and facilitates a second communicative connection in accordance with a memory fabric protocol associated with the memory of the host computer.

5. The system of claim 4, wherein the deep learning interface fabric protocol comprises a 2 virtual channel (2-VC) protocol.

6. The system of claim 4, wherein the cache-line configuration utilizes 64 byte cache lines.

7. The system of claim 4, wherein the word configuration utilizes a 16 bit word.

8. The system of claim 4, wherein the deep learning interface fabric protocol comprises a plurality of tile instructions enabling a pipelining of data to each of the plurality of tiles during the inference operation.

9. The system of claim 1, wherein the inference operation comprises an image recognition application.

10. A method of pipelining data to multiple tiles of a deep learning accelerator, comprising:
initiating an inference operation;
initiating a pipeline associated with the inference operation, wherein the pipeline comprises a plurality of consecutive intervals;
each of the multiple tiles requesting data during an interval; and
as the pipeline advances, a first tile of the multiple tiles performing a computation for an inference operation on requested data and other tiles of the multiple tiles waiting during a successive interval.

11. The method of claim 10, comprising:
as the pipeline further advances, the first tile of the multiple tiles completing a computation for an inference operation on requested data, a second tile of the multiple tiles initiating another computation for an inference operation on the requested data, and other tiles of the multiple tiles waiting during a successive interval.

12. The method of claim 10, wherein the first tile halts allowing an output from the inference operation to be sent to an host interface of the deep learning accelerator.

13. The method of claim 12, comprising:
as the pipeline further advances, the second tile of the multiple tiles completing the computation for an inference operation on the requested data, and the other tiles of the multiple tiles initiating a computation for an inference operation on the requested data during the successive interval.

14. The method of claim 13, wherein an output tile of the deep learning accelerator executes a send instruction to send the output from the inference operation to the host interface of the deep learning accelerator.

15. The method of claim 14, wherein the output tile of the deep learning accelerator, in response to the send instruction, further executes a barrier instruction to stall the output tile during sending the output from the inference operation to the host interface.

16. The method of claim 14, wherein the send instruction and the barrier instruction is in accordance with a deep learning interface fabric protocol.

17. The method of claim 13, comprising:
as the pipeline advances, each of the multiple tiles of the deep learning accelerator performing computations for an inference operation during successive intervals in a manner that increases utilization of each of the multiple tiles.

18. A deep learning accelerator system interface, comprising:
a switch, wherein the switch is connected to a plurality of tiles of a hardware accelerator;
a host interface, wherein the host interface is connected to a hardware interface of a server processor; and
a bridge, wherein the bridge is connected to the switch and the host interface, and facilitates a first communicative connection to the plurality of tiles and facilitates a second communicative connection to the host interface in a manner that connects the plurality of tiles to the server processor during an inference operation.

19. The deep learning accelerator system interface of claim 18, wherein the deep learning accelerator system interface and the hardware accelerator are on the same integrated circuit.

20. The deep learning accelerator system interface of claim 18, wherein the host interface connects to a Peripheral Component Interconnect Express (PCIe) interface of the server processor.
